(19) United States
(12) Patent Application Publication
(10) Pub. No.: US 2025/0168940 A1
(43) Pub. Date: May 22, 2025

(54) INDUCTION HEATER AND CONTROLLING METHOD THEREOF

(71) Applicant: SAMSUNG ELECTRONICS CO., LTD., Suwon-si (KR)

(72) Inventors: Hongjoo KANG, Suwon-si (KR); Heejoon KANG, Suwon-si (KR); Eundae BAE, Suwon-si (KR); Myoungjin HAM, Suwon-si (KR)

(73) Assignee: SAMSUNG ELECTRONICS CO., LTD., Suwon-si (KR)

(21) Appl. No.: 18/897,586

(22) Filed: Sep. 26, 2024

Related U.S. Application Data
(63) Continuation of application No. PCT/KR2024/013690, filed on Sep. 10, 2024.

(30) Foreign Application Priority Data
Nov. 21, 2023 (KR) 10-2023-0162756

(51) Int. Cl. H05B 6/06; H05B 6/12; H05B 6/44

(52) U.S. Cl. CPC H05B 6/065; H05B 6/1272; H05B 6/44

(57) ABSTRACT

An induction heating apparatus includes: a first heating portion including a single heating coil; a second heating portion including an inner heating coil and an outer heating coil; and a controller configured to control an operation of the first heating portion and an operation of the second heating portion. A maximum output frequency of an operation of the single heating coil is configured to be set higher than a maximum output frequency of a single operation of the inner heating coil of the second heating portion, and the maximum output frequency of the operation of the single heating coil is configured to be set lower than a maximum output frequency of simultaneous operations of the inner heating coil and the outer heating coil.

### CROSS REFERENCE TO THE RELATED APPLICATION

This application is a continuation application, filed under 35 U.S.C. § 111 (a), of International Application PCT/KR2024/013690 filed Sep. 10, 2024, and is based on and claims priority under 35 U.S.C. § 119 to Korean Patent Applications No. 10-2023-0162756, filed on Nov. 21, 2023 in the Korean Intellectual Property Office, the disclosures of which are incorporated by reference herein in their entireties.

### TECHNICAL FIELD

The disclosure relates to an induction heating apparatus including a dual heating coil and a method for controlling the same.

### BACKGROUND ART

In general, an induction heating apparatus is a cooking apparatus that heats and cooks food using the principle of induction heating. An induction heating apparatus includes a cooking plate on which a cooking vessel is placed, and a heating coil that generates a magnetic field when current is applied thereto.

When a current is applied to the heating coil and a magnetic field is generated, a secondary current is induced in the cooking vessel, and Joule heat is generated by a resistance component of the cooking vessel itself. Accordingly, the cooking vessel is heated by the high-frequency current and the food contained in the cooking vessel is cooked.

The induction heating apparatus, which uses the cooking vessel itself as a heat source, has a higher heat transfer rate compared to a gas range or kerosene stove that heats a cooking vessel by the heat of combustion from burning fossil fuel, thus generating no harmful gas and no risk of fire.

In a case where a plurality of heating coils of the induction heating apparatus operate simultaneously, noise may be generated due to different output frequencies.

### DISCLOSURE

According to an aspect of the disclosure, an induction heating apparatus and a method for controlling the same that may reduce noise by setting a maximum output frequency of each heating coil differently and matching the maximum output frequencies by duty ratio control.

Technical objects that can be achieved by the disclosure are not limited to the above-mentioned objects, and other technical objects not mentioned will be clearly understood by one of ordinary skill in the art to which the disclosure belongs from the following description.

According to an aspect of the disclosure, an induction heating apparatus may include: a first heating portion including a single heating coil; a second heating portion including an inner heating coil and an outer heating coil; and a controller configured to control an operation of the first heating portion and an operation of the second heating portion, wherein a maximum output frequency of an operation of the single heating coil may be set higher than a maximum output frequency of a single operation of the inner heating coil of the second heating portion, and the maximum output frequency of the operation of the single heating coil is configured to be set lower than a maximum output frequency upon simultaneous operation of the inner heating coil and the outer heating coil.

In respond to simultaneously operating the single heating coil of the first heating portion and the inner heating coil of the second heating portion, the controller may be configured to change the maximum output frequency of the single heating coil of the first heating portion to be identical to the maximum output frequency of the single operation of the inner heating coil.

The induction heating apparatus may further comprise a first switch configured to be connected to the first heating portion. The controller may be configured to change the maximum output frequency of the operation of the single heating coil by controlling a duty ratio of the first switch.

In response to simultaneously operating the single heating coil, the inner heating coil, and the outer heating coil, the controller may be configured to change the maximum output frequency of the simultaneous operations of the inner heating coil and the outer heating coil to be identical to the maximum output frequency of the single heating coil.

The induction heating apparatus may further comprises a second switch configured to be connected to the second heating portion, and the controller may be configured to change the maximum output frequency of the simultaneous operations of the inner heating coil and the outer heating coil by controlling a duty ratio of the second switch.

A difference between the maximum output frequency of the operation of the single heating coil and the maximum output frequency of the single operation of the inner heating coil may be 3 kHz or less.

A difference between the maximum output frequency of the operation of the single heating coil and the maximum output frequency of the simultaneous operations of the inner heating coil and the outer heating coil may be 3 kHz or less.

The second heating portion may comprise a dual heating coil which includes the inner heating coil and the outer heating coil, and the inner heating coil is operable independently from the outer heating coil or simultaneously operable with the outer heating coil.

The second heating portion may further comprise a gap between the inner heating coil and the outer heating coil.

A method for controlling an induction heating apparatus may comprise a first heating portion including a single heating coil, and a second heating portion including an inner heating coil and an outer heating coil.

The method may comprise setting a maximum output frequency of the single heating coil to be higher than a maximum output frequency based on a single operation of the inner heating coil, and lower than a maximum output frequency of simultaneous operations of the inner heating coil and the outer heating coil; and in response to simultaneously operating the single heating coil and the inner heating coil, changing the maximum output frequency of the operation of the single heating coil to be identical to the maximum output frequency of the single operation of the inner heating coil.

The induction heating apparatus may further comprise: a first switch configured to be connected to the first heating portion, and the changing of the maximum output frequency of the operation of the single heating coil comprises changing the maximum output frequency of the operation of the single heating coil by controlling a duty ratio of the first switch.

The method may further comprises: in response to simultaneously operating the single heating coil, the inner heating coil, and the outer heating coil, changing the maximum output frequency of the simultaneous operations of the inner heating coil and the outer heating coil to be identical to the maximum output frequency of the operation of the single heating coil.

The induction heating apparatus may further comprises a second switch configured to be connected to the second heating portion, and the changing of the maximum output frequency of the simultaneous operations of the inner heating coil and the outer heating coil comprises changing the maximum output frequency of the simultaneous operations of the inner heating coil and the outer heating coil by controlling a duty ratio of the second switching portion.

A difference between the maximum output frequency of the operation of the single heating coil and the maximum output frequency of the single operation of the inner heating coil may be 3 kHz or less.

A difference between the maximum output frequency of the operation of the single heating coil and the maximum output frequency of the simultaneous operations of the inner heating coil and the outer heating coil may be 3 kHz or less.

The second heating portion may comprise a dual heating coil which includes the inner heating coil and the outer heating coil, and the inner heating coil is operable independently from the outer heating coil or simultaneously operable with the outer heating coil.

The second heating portion may further comprise a gap between the inner heating coil and the outer heating coil.

### DESCRIPTION OF DRAWINGS

FIG. 1 is a diagram illustrating an exterior of an induction heating apparatus according to an embodiment of the disclosure.

FIG. 2 and FIG. 3 are diagrams for illustrating a heating principle of an induction heating apparatus according to an embodiment of the disclosure.

FIG. 4 is a diagram illustrating an example of resonant circuitry according to an embodiment of the disclosure.

FIG. 5 is a diagram illustrating an induction heating apparatus including a dual heating coil according to an embodiment of the disclosure.

FIG. 6 is a diagram illustrating an operating principle of a dual heating coil according to an embodiment of the disclosure.

FIGS. 7A and 7B illustrates setting a maximum output frequency of each heating coil differently according to an embodiment of the disclosure.

FIG. 8 is a control block diagram of an induction heating apparatus according to an embodiment of the disclosure.

FIGS. 9A and 9B illustrates matching maximum output frequencies by duty ratio control according to an embodiment of the disclosure.

FIGS. 10A and 10B illustrates matching different maximum output frequencies of each heating coil according to an embodiment of the disclosure.

FIG. 11 and FIG. 12 are flowcharts illustrating a method for controlling an induction heating apparatus according to an embodiment of the disclosure.

### MODES OF THE DISCLOSURE

Embodiments described in the specification and configurations shown in the accompanying drawings are merely examples of the disclosure, and various modifications may replace the embodiments and the drawings of the disclosure at the time of filing of the application.

Like reference numerals or symbols denoted in the drawings of the specification are members or components that perform the substantially same functions.

The terms used herein are for the purpose of describing the embodiments and are not intended to restrict and/or to limit the present disclosure. For example, the singular expressions herein may include plural expressions, unless the context clearly dictates otherwise. The terms “comprise” and “have” are intended to indicate that there are features, numbers, steps, operations, elements, parts, or combinations thereof described in the specification, and do not exclude the presence or addition of one or more other features, numbers, steps, operations, elements, parts, or combinations thereof.

It is to be understood that when one component is referred to as being “connected to” or “coupled to” another component, it means that the component may be connected to or coupled to the other component directly or indirectly through a third component.

It is to be understood that that, although the terms including ordinal numbers, such as “first”, “second”, etc., may be used herein to describe various components, these components should not be limited by these terms. These terms are only used to distinguish one component from another. For example, a first component could be termed a second component, and, similarly, a second component could be termed a first component, without departing from the scope of the disclosure. As used herein, the term “and/or” includes any and all combinations of one or more of associated listed items.

Hereinafter, an operation principle and embodiments will be described in detail with reference to the accompanying drawings.

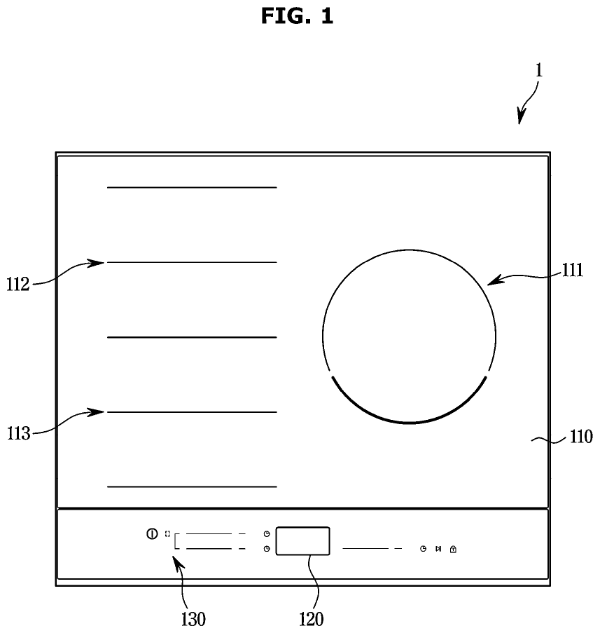

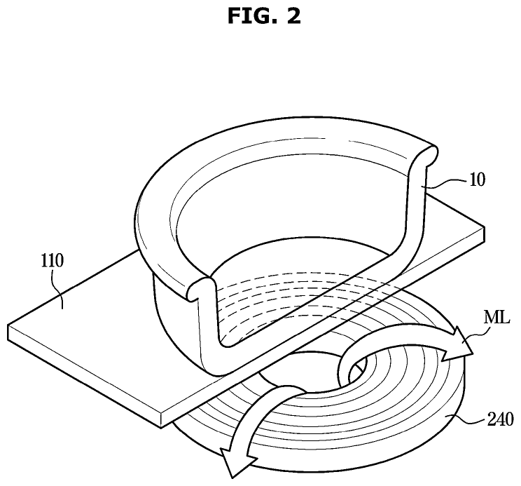

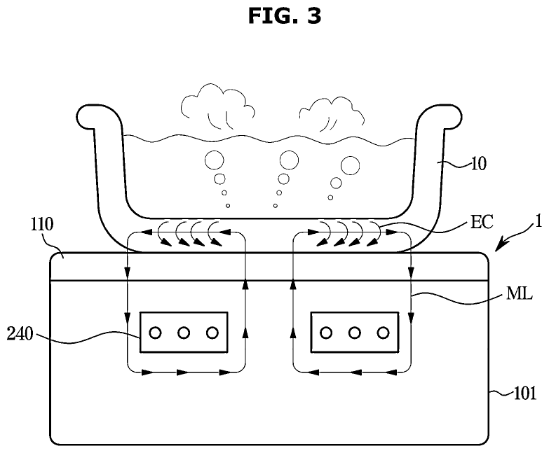

FIG. 1 is a diagram illustrating an exterior of an induction heating apparatus according to an embodiment of the disclosure. FIG. 2 and FIG. 3 are diagrams for illustrating a heating principle of an induction heating apparatus according to an embodiment of the disclosure.

In FIG. 1, a top view of an induction heating apparatus 1 according to an embodiment is illustrated. As shown in FIG. 1, the induction heating apparatus 1 according to an embodiment may include a plate 110 provided on an upper portion of a main body 101, cooking zones 111, 112, and 113 formed on the plate 110, and user interfaces 120 and 130 serving as input/output devices. For example, the plate 110 may be implemented with ceramic.

The cooking zones 111, 112, and 113 may represent positions in which the cooking vessels may be placed, and may be indicated in a circular shape (denoted by a reference numeral 111) or in a straight boundary line (denoted by reference numerals 112 and 113) to guide proper arrangement of the cooking vessels.

However, the above-described shapes are only examples of shapes for representing the cooking zones 111, 112, and 113, and without being limited to a circular or straight shape, various shapes may be applied to embodiments of the induction heating apparatus 1 as long as it may guide the user to the position of the cooking zone.

In addition, the present example is illustrated as having three cooking zones on the plate 110, but the embodiment of the induction heating apparatus 1 is not limited thereto. Only one cooking zone may be formed, and four or more cooking zones may be formed.

In one area of the plate 110, a display 120 and an input device 130 may be provided. The display 120 may include a display device, such as an Liquid Crystal Display (LCD) or a Light Emitting Diode (LED), and the input device 130 may include at least one of various input devices, such as a touch pad, a button, or a jog shuttle. Alternatively, the display 120 and the input device 130 may be implemented as a touch screen.

In the present example, a case in which the display 120 and the input device 130 are provided at positions spaced apart from the cooking zones 111, 112, and 113 on the plate 110 is illustrated. However, the arrangement shown in FIG. 1 is only an example applicable to the induction heating apparatus 1, and the display 120 or input device 130 may be placed at a position other than on the plate 110, such as the front of the induction heating apparatus 1.

Referring to FIG. 2 and FIG. 3 in conjunction with FIG. 1, a heating coil 240 used to heat a vessel 10 placed on the plate 110 may be disposed below the plate 110. For convenience of description, only single heating coil 240 is illustrated in FIG. 2 and FIG. 3, but the heating coil 240 may be provided corresponding in number to the number of cooking zones.

In a case where three cooking zones 111, 112, and 113 are provided as shown in the example of FIG. 1, the heating coil 240 may be provided as three heating coils 240, and each of the heating coils 240 may be placed on a lower side of a corresponding one of the cooking zones 111, 112, and 113.

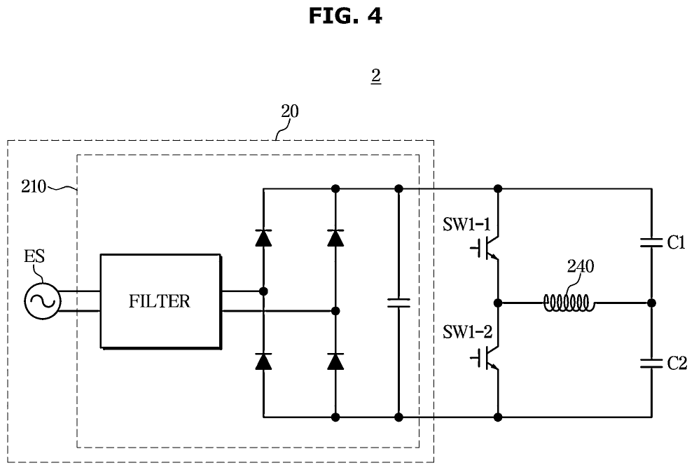

The heating coil 240 may be connected to a resonant circuitry 2 (see FIG. 4) to be described below, and may be supplied with a high-frequency current from the resonant circuitry 2. For example, the frequency of the high frequency current may be in a range of 20 kHz to 35 KHz.

By supplying a high frequency current to the heating coil 240, lines of magnetic force ML may be formed in or about the heating coil 240. In a case where the vessel 10 having resistance is located within a range which the lines of magnetic force ML reach, the lines of magnetic force ML around the heating coil 240 may pass through the bottom of the vessel 10, generating an induced current in the form of a vortex according to the law of electromagnetic induction, that is, eddy currents (EC).

The eddy current EC may interact with the electrical resistance of the vessel 10, generating heat in or on the vessel 10, and the generated heat may heat the food inside the vessel 10.

In the induction heating apparatus 1, the vessel 10 itself acts as a heat source, and a metal having a resistance of a certain level or higher, such as iron, stainless steel, or nickel, may be used as a material of the vessel 10.

On the other hand, the specifications of the heating coil 240 may be designed to vary according to the rated voltage of the country in which the induction heating apparatus 1 is sold.

FIG. 4 is a diagram illustrating an example of resonant circuitry according to an embodiment of the disclosure.

Referring to FIG. 4, the resonant circuitry 2 may include a power supply module 20.

The power supply module 20 may include a power supply ES and a rectifier 210.

The power supply ES is an AC power supply ES, and may provide a power supply ES corresponding to a rated voltage.

The rectifier 210 may convert the AC voltage supplied from the power supply ES into a DC voltage.

To this end, the rectifier 210 may include bridge rectifier circuitry including a plurality of diodes. For example, the bridge rectifier circuitry may include four diodes. The diodes may form two pairs of diodes, each pair of diodes obtained by connecting diodes in series, and the two pairs of diodes may be connected in parallel with each other. The bridge diode may convert an AC voltage, of which the polarity changes over time, into a voltage, of which the polarity is constant, and convert an AC current, of which the direction changes over time, into a current, of which the direction is constant.

In addition, the rectifier 210 may include a direct current (DC) link capacitor. The DC link capacitor may convert a voltage of which the magnitude changes over time into a DC voltage of a constant size. The DC link capacitor may maintain the converted DC voltage and provide the DC voltage to inverter circuitry SW1-1 and SW1-2. In this case, the inverter circuitry SW1-1 and SW1-2 may include the first switching element SW1-1 and the second switching element SW1-2 of a first switching portion.

The first switching element SW1-1 and the second switching element SW1-2 of the first switching portion may operate in a complementary manner to allow an alternating current to flow through the heating coil 240.

The first switching element SW1-1 and the second switching element SW1-2 of the first switching portion may be implemented as a three-terminal semiconductor device switch having a fast response speed so as to be turned on/off at a high speed. For example, the first switching element SW1-1 and the second switching element SW1-2 of the first switching portion may be provided as a Bipolar Junction Transistor (BJT), a Metal-Oxide-Semiconductor Field Effect Transistor (MOSFET), an Insulated Gate Bipolar Transistor (IGBT) or a thyristor.

The first switching element SW1-1 and the second switching element SW1-2 of the first switching portion may be turned on/off by switch driving signals. In this case, the switch driving signals may be provided by a controller 150, and the controller 150 may alternately turn on/off the first switching element SW1-1 and the second switching element SW1-2 of the first switching portion, thereby supplying the heating coil 240 with a high-frequency alternating current.

The resonant circuitry 2 may further include a filter that removes noise components included in the power supplied from the power supply ES. The filter may be composed of a transformer and a capacitor to remove noise mixed with power supplied from the power supply ES, and may provide AC power from which noise has been removed to the rectifier 210.

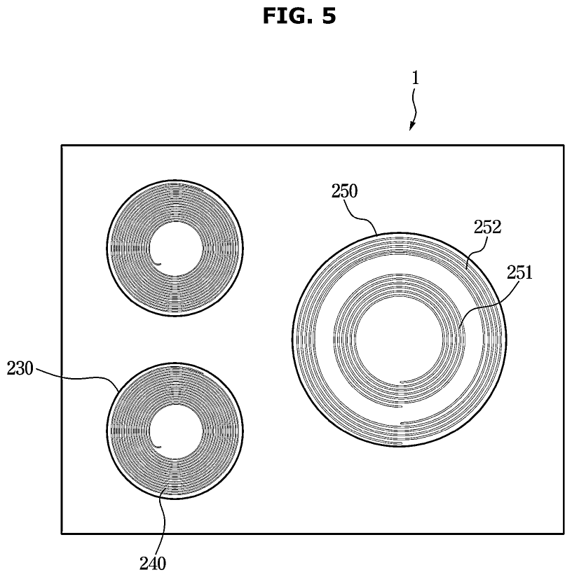

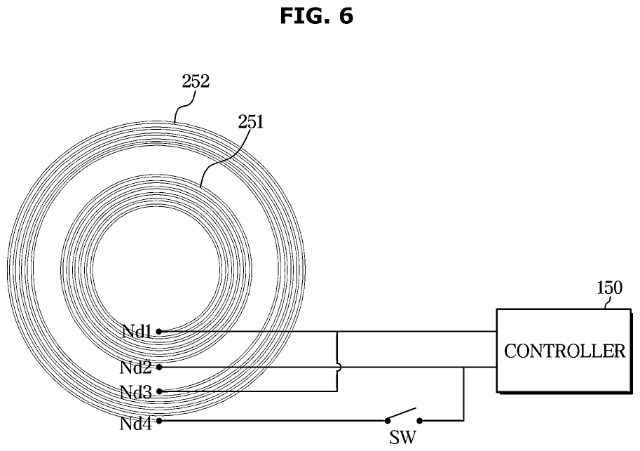

FIG. 5 is a diagram illustrating an induction heating apparatus including a dual heating coil according to an embodiment of the disclosure. FIG. 6 is a diagram illustrating an operating principle of a dual heating coil according to an embodiment of the disclosure.

A dual heating coil 250 may operate in operation modes that includes a dual mode for heating a first area and a single mode for heating a second area that is smaller than the first area, depending on the size of a bottom side of an object to be heated (heating object). For example, the dual heating coil 250 may include an inner heating coil 251 and an outer heating coil 252. The dual heating coil 250 may operate in the single mode for heating only the inner area by the inner heating coil 251 and in the dual mode for heating both the inner area and the outer area by the inner heating coil 251 and the outer heating coil 252. The operation mode of the dual heating coil 250 may be determined by the controller 150.

The induction heating apparatus 1 may detect a heating object placed on a cooking zone, and may determine an operation mode of the dual heating coil 250 based on the size of the bottom side of the detected heating object as one of the dual mode and the single mode. Alternatively, the dual heating coil 250 may be controlled to perform one of the dual mode or the single mode based on a user input, or the like.

The dual heating coil 250 may include the inner heating coil 251 located in an inner region and the outer heating coil 252 located in an outer region. The inner and outer regions may be donut-shaped regions having a single point as a common center. The inner and outer regions may have a gap therebetween. However, the dual heating coil 250 region is not limited thereto, and no gap may exist between the inner and outer regions.

The inner heating coil 251 and the outer heating coil 252 may be connected in parallel. For example, a first node Nd1 of the inner heating coil 251 may be connected to a third node Nd3 of the outer heating coil 252, and a second node Nd2 of the inner heating coil 251 may be connected to a fourth node Nd4 of the outer heating coil 252 via a dual switching portion SW.

The controller 150 may supply power to the inner heating coil 251 and/or the outer heating coil 252. For example, in a case where the dual heating coil 250 operates in the dual mode, the controller 150 may turn on the dual switching portion to allow the inner heating coil 251 and the outer heating coil 252 to operate together. In addition, in a case where the dual heating coil 250 operates in the single mode, the controller 150 may turn off the dual switching portion to allow only the inner heating coil 251 to operate.

As such, the induction heating apparatus 1 may include the dual heating coil 250 including the inner heating coil 251 and the outer heating coil 252.

Design modifications and control operations for noise reduction in the induction heating apparatus 1 including the above-described dual heating coil 250 will be described below.

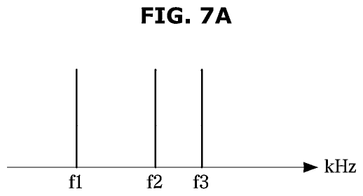

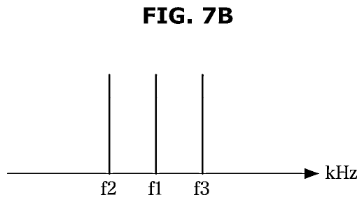

FIG. 7 illustrates setting a maximum output frequency of each heating coil differently according to an embodiment of the disclosure.

As described above, in a case where a plurality of heating coils included in the induction heating apparatus 1 operate simultaneously, noise may be generated due to different output frequencies.

In the disclosure, described is a case where a first heating portion 230 including the single heating coil 240 and a second heating portion 250 including the inner heating coil 251 and the outer heating coil 252 operate simultaneously. Here, the second heating portion 250 may include the above-described dual heating coil 250 including the inner heating coil 251 and the outer heating coil 252.

Referring to FIG. 7A, a maximum output frequency f1 of a single heating coil may be set lower than a maximum output frequency f2 upon single operation of the inner heating coil and lower than a maximum output frequency f3 upon simultaneous operation of the inner heating coil and the outer heating coil. Further, the maximum output frequency f2 upon single operation of the inner heating coil may be set lower than the maximum output frequency f3 upon simultaneous operation of the inner heating coil and the outer heating coil.

Because operation of a plurality of heating coils at different output frequencies may cause noise, a method such as duty ratio control may be used to allow a relatively higher frequency to match a lower frequency.

However, because frequency reduction methods using duty ratio control are generally limited to a range of approximately 3 kHz, in a case where a difference between the frequencies exceeds 3 kHz, the frequencies may not match even with duty ratio control.

In a case where the maximum output frequency of each heating coil is set as shown in FIG. 7A and the single heating coil 240 and the inner heating coil 251 operate simultaneously, the maximum output frequency f2 upon single operation of the inner heating coil may be reduced by the maximum output frequency f1 of the single heating coil through duty ratio control.

However, because the maximum output frequency f3 upon simultaneous operation of the inner heating coil and the outer heating coil is higher than the maximum output frequency f2 upon single operation of the inner heating coil, in a case where the single heating coil 240, the inner heating coil 251, and the outer heating coil 252 operate simultaneously, a difference between the maximum output frequency f3 upon simultaneous operation of the inner heating coil and the outer heating coil and the maximum output frequency f1 of the single heating coil may exceed 3 kHz. As a result, the frequencies may not match even with duty ratio control.

Accordingly, according to an embodiment of the disclosure, as shown in FIG. 7B, the maximum output frequency f1 of the single heating coil may be set higher than the maximum output frequency f2 upon single operation of the inner heating coil and lower than the maximum output frequency f3 upon simultaneous operation of the inner heating coil and the outer heating coil.

By setting the maximum output frequency of each of the heating coils, in a case where the single heating coil 240 and the inner heating coil 251 operate simultaneously as will be described later, the maximum output frequency f1 of the single heating coil may be reduced by the maximum output frequency f2 upon single operation of the inner heating coil, and in a case where the single heating coil 240, the inner heating coil 251, and the outer heating coil 252 operate simultaneously, the maximum output frequency f3 upon simultaneous operation of the inner heating coil and the outer heating coil may be reduced by the maximum output frequency f1 of the single heating coil.

As described above, because the frequency reduction method using duty ratio control is usually limited to a range of approximately 3 kHz, the difference between the maximum output frequency f1 of the single heating coil and the maximum output frequency f2 upon single operation of the inner heating coil may be 3 kHz or less. In addition, the difference between the maximum output frequency f1 of the single heating coil and the maximum output frequency f3 upon simultaneous operation of the inner heating coil and the outer heating coil may also be 3 kHz or less.

By setting the maximum output frequencies of the plurality of heating coils differently, noise reduction by duty ratio control upon simultaneous operation may be facilitated. Hereinafter, an operation for matching maximum output frequencies for noise reduction in a case where heating coils with different maximum output frequencies operate simultaneously is described.

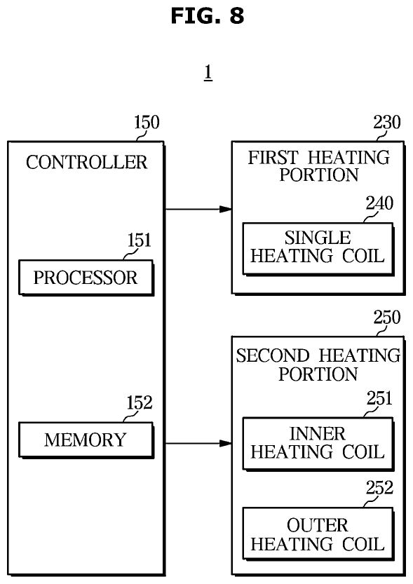

FIG. 8 is a control block diagram of an induction heating apparatus according to an embodiment of the disclosure.

The induction heating apparatus 1 may include the first heating portion 230 including the single heating coil 240, and the second heating portion 250 including the inner heating coil 251 and the outer heating coil 252, and may further include the controller 150 controlling an operation of the first heating portion 230 and an operation of the second heating portion 250. The controller 150 may include a processor and memory. Here, the second heating portion 250 may include a dual heating coil 250 including the inner heating coil 251 and the outer heating coil 252, as described above.

The controller 150 may include memory 152 for storing a control program and control data for controlling the first heating portion 230 and the second heating portion 250, and at least one processor 151 generating a control signal according to the control program and control data stored in the memory. The memory 152 and the processor 151 may be provided integrally or separately.

The memory 152 may store a program and data for controlling the first heating portion 230 and the second heating portion 250.

The memory 152 may include a volatile memory, such as Static Random Access Memory (S-RAM) or Dynamic Random Access Memory (D-RAM), for temporary storage of data. The memory 152 may include a non-volatile memory, such as Read Only Memory (ROM), Erasable Programmable Read Only Memory (EPROM), or Electrically Erasable Programmable Read Only Memory (EEPROM), for long-term storage of data.

The processor 151 may include various logic circuitry and operation circuitry, may process data according to the program provided from the memory, and may generate a control signal according to the processed data.

In a case where the single heating coil 240 and the inner heating coil 251 operate simultaneously (in a case where the single heating coil 240 and the dual heating coil 250 operate simultaneously in the single mode described above), the controller 150 may change the maximum output frequency f1 of the single heating coil to allow the maximum output frequency f1 of the single heating coil and the maximum output frequency f2 upon single operation of the inner heating coil to be identical to each other.

That is, as shown in FIG. 7B, the maximum output frequency f1 of the single heating coil is set higher than the maximum output frequency f2 upon single operation of the inner heating coil, and thus the maximum output frequency f1 of the single heating coil may be changed to match the maximum output frequency f2 upon single operation of the inner heating coil.

In addition, in a case where the single heating coil 240, the inner heating coil 251, and the outer heating coil 252 operate simultaneously (in a case where the single heating coil 240 and the dual heating coil 250 operate simultaneously in the dual mode described above), the controller 150 may change the maximum output frequency upon simultaneous operation of the inner heating coil 251 and the outer heating coil 252 to allow the maximum output frequency f1 of the single heating coil and the maximum output frequency f3 upon simultaneous operation of the inner heating coil and the outer heating coil to be identical to each other.

That is, as shown in FIG. 7B, because the maximum output frequency f3 upon simultaneous operation of the inner heating coil and the outer heating coil is set higher than the maximum output frequency f1 of the single heating coil, the maximum output frequency f3 upon simultaneous operation of the inner heating coil and the outer heating coil may be changed to match the maximum output frequency f1 of the single heating coil.

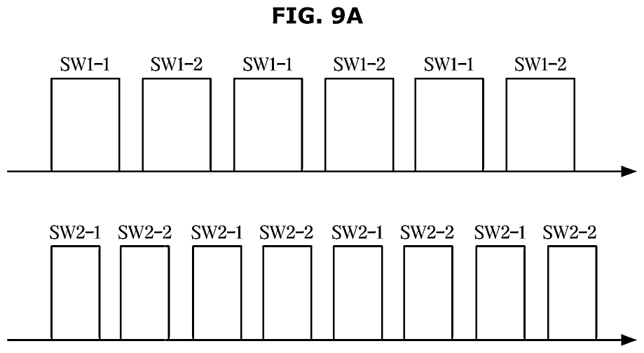

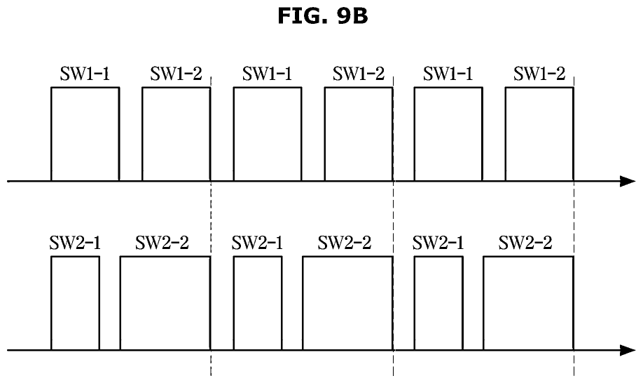

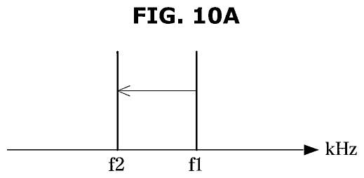

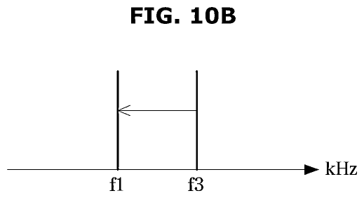

FIG. 9 illustrates matching maximum output frequencies by duty ratio control according to an embodiment of the disclosure. FIG. 10 illustrates matching different maximum output frequencies of each heating coil according to an embodiment of the disclosure.

The induction heating apparatus 1 may further include a first switching portion SW1 connected to the first heating portion 230, and a second switching portion SW2 connected to the second heating portion 250.

The switching portions may be turned on/off by a switching drive signal. That is, the controller 150 may supply a high frequency alternating current to the first heating portion 230 by alternately turning on/off the first switching element SW1-1 of the first switching portion and the second switching element SW1-2 of the first switching portion.

In addition, the controller 150 may supply a high frequency alternating current to the second heating portion 250 by alternately turning on/off a first switching element SW2-1 of the second switching portion and a second switching element SW2-2 of the second switching portion.

As described above, the controller 150 may match maximum output frequencies through duty ratio control that regulates an on/off ratio of the switching portion.

That is, in a case where the single heating coil 240 and the inner heating coil 251 operate simultaneously, the controller 150 may perform duty ratio control for the first switching portion SW1 to allow the maximum output frequency f1 of the single heating coil and the maximum output frequency f2 upon single operation of the inner heating coil to be identical to each other, and thus the maximum output frequency f1 of the single heating coil may be changed.

In addition, in a case where the single heating coil 240, the inner heating coil 251, and the outer heating coil 252 operate simultaneously, the controller 150 may perform duty ratio control for the second switching portion SW2 to allow the maximum output frequency f1 of the single heating coil and the maximum output frequency f3 upon simultaneous operation of the inner heating coil 251 and the outer heating coil 252 to be identical to each other, and thus the maximum output frequency f3 upon simultaneous operation of the inner heating coil and the outer heating coil may be changed.

In FIG. 9, an example of performing duty ratio control for the second switching portion SW2 is illustrated. Here, it may be seen that before performing the duty ratio control, the maximum output frequency f1 of the single heating coil is different from the maximum output frequency f3 upon simultaneous operation of the inner heating coil and the outer heating coil as shown in FIG. 9A, but after performing the duty ratio control, the maximum output frequency f3 upon simultaneous operation of the inner heating coil and the outer heating coil is reduced to match the maximum output frequency f1 of the single heating coil, as shown in FIG. 9B.

In other words, in a case where the single heating coil 240 and the inner heating coil 251 operate simultaneously, as shown in FIG. 10A, the maximum output frequency f1 of the single heating coil may be reduced to match the maximum output frequency f2 upon single operation of the inner heating coil, and in a case where the single heating coil 240, the inner heating coil 251, and the outer heating coil 252 operate simultaneously, as shown in FIG. 10B, the maximum output frequency f3 upon simultaneous operation of the inner heating coil and the outer heating coil may be reduced to match the maximum output frequency f1 of the single heating coil.

According to the duty ratio control, the maximum output frequencies may match even in a case where the plurality of heating coils operate simultaneously, thereby reducing noise.

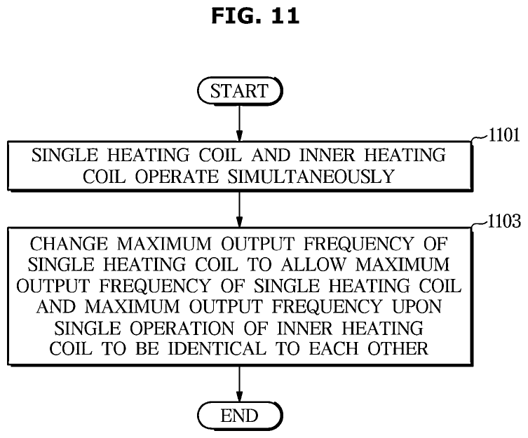

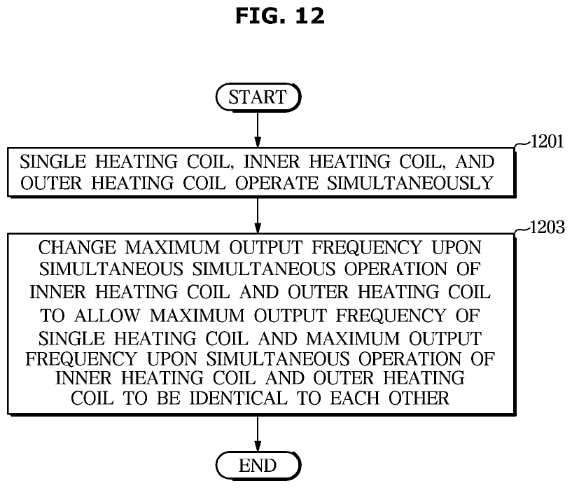

FIG. 11 and FIG. 12 are flowcharts illustrating a method for controlling an induction heating apparatus according to an embodiment of the disclosure.

In a case where the single heating coil 240 and the inner heating coil 251 operate simultaneously (in a case where the single heating coil 240 and the dual heating coil 250 operate simultaneously in the single mode described above, 1101), the maximum output frequency of the single heating coil 240 may be changed (1103) to allow the maximum output frequency f1 of the single heating coil and the maximum output frequency f2 upon single operation of the inner heating coil to be identical to each other.

In other words, as shown in FIG. 7B, because the maximum output frequency f1 of the single heating coil is set higher than the maximum output frequency f2 upon single operation of the inner heating coil, the maximum output frequency f1 of the single heating coil may be changed to match the maximum output frequency f2 upon single operation of the inner heating coil.

In this case, duty ratio control for the first switching part SW1 may be performed, and thus the maximum output frequency f1 of the single heating coil may be changed.

In addition, in a case where the single heating coil 240, the inner heating coil 251, and the outer heating coil 252 operate simultaneously (in a case where the single heating coil 240 and the dual heating coil 250 operate simultaneously in the dual mode described above, 1201), the maximum output frequency upon simultaneous operation of the inner heating coil 251 and the outer heating coil 252 may be changed to allow the maximum output frequency f1 of the single heating coil and the maximum output frequency f3 upon simultaneous operation of the inner heating coil and the outer heating coil to be identical to each other (1203).

In other words, as shown in FIG. 7B, because the maximum output frequency f3 upon simultaneous operation of the inner heating coil and the outer heating coil is set higher than the maximum output frequency f1 of the single heating coil, the maximum output frequency f3 upon simultaneous operation of the inner heating coil and the outer heating coil may be changed to match the maximum output frequency f1 of the single heating coil.

In this case, duty ratio control for the second switching part SW2 may be performed, and thus, the maximum output frequency f3 upon simultaneous operation of the inner heating coil and the outer heating coil may be changed.

According to an embodiment of the disclosure, an induction heating apparatus may include: a first heating portion including a single heating coil; a second heating portion including an inner heating coil and an outer heating coil; and a controller configured to control an operation of the first heating portion and an operation of the second heating portion, wherein a maximum output frequency of the single heating coil may be set higher than a maximum output frequency upon single operation of the inner heating coil, and lower than a maximum output frequency upon simultaneous operation of the inner heating coil and the outer heating coil.

According to the disclosure, noise may be reduced by setting a maximum output frequency of each heating coil differently and matching the maximum output frequencies by duty ratio control.

In a case where the single heating coil and the inner heating coil operate simultaneously, the controller may be configured to change the maximum output frequency of the single heating coil to allow the maximum output frequency of the single heating coil and the maximum output frequency upon single operation of the inner heating coil to be identical to each other.

The induction heating apparatus may further include a first switching portion configured to be connected to the first heating portion, wherein the controller may be configured to change the maximum output frequency of the single heating coil by controlling a duty ratio of the first switching portion.

In a case where the single heating coil, the inner heating coil, and the outer heating coil operate simultaneously, the controller may be configured to change the maximum output frequency upon simultaneous operation of the inner heating coil and the outer heating coil to allow the maximum output frequency of the single heating coil and the maximum output frequency upon simultaneous operation of the inner heating coil and the outer heating coil to be identical to each other.

The induction heating apparatus may further include a second switching portion configured to be connected to the second heating portion, wherein the controller may be configured to change the maximum output frequency upon simultaneous operation of the inner heating coil and the outer heating coil by controlling a duty ratio of the second switching portion.

A difference between the maximum output frequency of the single heating coil and the maximum output frequency upon single operation of the inner heating coil may be 3 kHz or less.

A difference between the maximum output frequency of the single heating coil and the maximum output frequency upon simultaneous operation of the inner heating coil and the outer heating coil may be 3 kHz or less.

According to an embodiment of the disclosure, in a method for controlling an induction heating apparatus including a first heating portion including a single heating coil and a second heating portion including an inner heating coil and an outer heating coil, the method may include: setting a maximum output frequency of the single heating coil to be higher than a maximum output frequency upon single operation of the inner heating coil, and lower than a maximum output frequency upon simultaneous operation of the inner heating coil and the outer heating coil; and in a case where the single heating coil and the inner heating coil operate simultaneously, changing the maximum output frequency of the single heating coil to allow the maximum output frequency of the single heating coil and the maximum output frequency upon single operation of the inner heating coil to be identical to each other.

The induction heating apparatus may further include a first switching portion configured to be connected to the first heating portion, and the changing of the maximum output frequency of the single heating coil may include changing the maximum output frequency of the single heating coil by controlling a duty ratio of the first switching portion.

The method may further include, in a case where the single heating coil, the inner heating coil, and the outer heating coil operate simultaneously, changing the maximum output frequency upon simultaneous operation of the inner heating coil and the outer heating coil to allow the maximum output frequency of the single heating coil and the maximum output frequency upon simultaneous operation of the inner heating coil and the outer heating coil to be identical to each other.

The induction heating apparatus may further include a second switching portion configured to be connected to the second heating portion, and the changing of the maximum output frequency upon simultaneous operation of the inner heating coil and the outer heating coil may include changing the maximum output frequency upon simultaneous operation of the inner heating coil and the outer heating coil by controlling a duty ratio of the second switching portion.

A difference between the maximum output frequency of the single heating coil and the maximum output frequency upon single operation of the inner heating coil may be 3 kHz or less.

A difference between the maximum output frequency of the single heating coil and the maximum output frequency upon simultaneous operation of the inner heating coil and the outer heating coil may be 3 kHz or less.

According to the disclosure, noise may be reduced by setting a maximum output frequency of each heating coil differently and matching the maximum output frequencies by duty ratio control.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

What is claimed is:

1. An induction heating apparatus, comprising:
a first heating portion including a single heating coil;
a second heating portion including an inner heating coil and an outer heating coil; and
a controller configured to control an operation of the first heating portion and an operation of the second heating portion,
wherein a maximum output frequency of an operation of the single heating coil is configured to be set higher than a maximum output frequency of a single operation of the inner heating coil of the second heating portion, and the maximum output frequency of the operation of the single heating coil is configured to be set lower than a maximum output frequency of simultaneous operations of the inner heating coil and the outer heating coil.

2. The induction heating apparatus of claim 1, wherein in respond to simultaneously operating the single heating coil of the first heating portion and the inner heating coil of the second heating portion, the controller is configured to change the maximum output frequency of the single heating coil of the first heating portion to be identical to the maximum output frequency of the single operation of the inner heating coil.

3. The induction heating apparatus of claim 2, further comprising:
a first switch configured to be connected to the first heating portion,
wherein the controller is configured to change the maximum output frequency of the operation of the single heating coil by controlling a duty ratio of the first switch.

4. The induction heating apparatus of claim 1, wherein in response to simultaneously operating the single heating coil, the inner heating coil, and the outer heating coil, the controller is configured to change the maximum output frequency of the simultaneous operations of the inner heating coil and the outer heating coil to be identical to the maximum output frequency of the single heating coil.

5. The induction heating apparatus of claim 4, further comprising:
a second switch configured to be connected to the second heating portion,
wherein the controller is configured to change the maximum output frequency of the simultaneous operations of the inner heating coil and the outer heating coil by controlling a duty ratio of the second switch.

6. The induction heating apparatus of claim 1, wherein a difference between the maximum output frequency of the operation of the single heating coil and the maximum output frequency of the single operation of the inner heating coil is 3 kHz or less.

7. The induction heating apparatus of claim 1, wherein a difference between the maximum output frequency of the operation of the single heating coil and the maximum output frequency of the simultaneous operations of the inner heating coil and the outer heating coil is 3 kHz or less.

8. The induction heating apparatus of claim 1, wherein the second heating portion comprises a dual heating coil which includes the inner heating coil and the outer heating coil, and the inner heating coil is operable independently from the outer heating coil or simultaneously operable with the outer heating coil.

9. The induction heating apparatus of claim 8, wherein the second heating portion further comprises a gap between the inner heating coil and the outer heating coil.

10. A method for controlling an induction heating apparatus comprising a first heating portion including a single heating coil, and a second heating portion including an inner heating coil and an outer heating coil, the method comprising:
setting a maximum output frequency of the single heating coil to be higher than a maximum output frequency based on a single operation of the inner heating coil, and lower than a maximum output frequency of simultaneous operations of the inner heating coil and the outer heating coil; and
in response to simultaneously operating the single heating coil and the inner heating coil, changing the maximum output frequency of the operation of the single heating coil to be identical to the maximum output frequency of the single operation of the inner heating coil.

11. The method of claim 10, wherein the induction heating apparatus further comprises:
a first switch configured to be connected to the first heating portion, and
the changing of the maximum output frequency of the operation of the single heating coil comprises changing the maximum output frequency of the operation of the single heating coil by controlling a duty ratio of the first switch.

12. The method of claim 11, further comprising:
in response to simultaneously operating the single heating coil, the inner heating coil, and the outer heating coil, changing the maximum output frequency of the simultaneous operations of the inner heating coil and the outer heating coil to be identical to the maximum output frequency of the operation of the single heating coil.

13. The method of claim 12, wherein the induction heating apparatus further comprises:
a second switch configured to be connected to the second heating portion, and
the changing of the maximum output frequency of the simultaneous operations of the inner heating coil and the outer heating coil comprises changing the maximum output frequency of the simultaneous operations of the inner heating coil and the outer heating coil by controlling a duty ratio of the second switching portion.

14. The method of claim 10, wherein a difference between the maximum output frequency of the operation of the single heating coil and the maximum output frequency of the single operation of the inner heating coil is 3 kHz or less.

15. The method of claim 10, wherein a difference between the maximum output frequency of the operation of the single heating coil and the maximum output frequency of the simultaneous operations of the inner heating coil and the outer heating coil is 3 kHz or less.

16. The method of claim 10, wherein the second heating portion comprises a dual heating coil which includes the inner heating coil and the outer heating coil, and the inner heating coil is operable independently from the outer heating coil or simultaneously operable with the outer heating coil.

17. The method of claim 10, wherein the second heating portion further comprises a gap between the inner heating coil and the outer heating coil.
